(19) United States
(12) Patent Application Publication
(10) Pub. No.: US 2026/0073193 A1
(43) Pub. Date: Mar. 12, 2026

(54) GENERATIVE MODEL-ASSISTED CONTENT GENERATION AND INTERACTIVE CONTENT EDITING

(71) Applicant: Adobe Inc., San Jose, CA (US)

(72) Inventors: Varsha SANKAR, Mountain View, CA (US); Shankar VENKITACHALAM, Fremont, CA (US); Meghanath MY, San Jose, CA (US); Deepak PAI, Sunnyvale, CA (US); Debraj Debashish BASU, Sunnyvale, CA (US)

(21) Appl. No.: 18/828,211

(22) Filed: Sep. 9, 2024

(51) Int. Cl. G06N 3/0475; G06N 3/045

(52) U.S. Cl. CPC G06N 3/0475; G06N 3/045

(57) ABSTRACT

Some aspects relate to technologies for employing generative models for content generation and interactive content editing. In accordance with some aspects, user input is received for generating a content item of a content type having a number of fragments. A model set for the content type is identified. The model set comprises generative models for the fragments and an execution order specifying an order for generating the fragments. A root generative model from the model set is caused to generate text for a root fragment in the execution order based on the user input. Each subsequent generative model in the model set is sequentially caused to generate text for each subsequent fragment in the execution order for the model set, wherein input for each subsequent generative model includes text of any previous fragments in the execution order. The content item is generated by combining the text of the fragments.

### BACKGROUND

In the context of marketing, a content delivery system refers to a platform or set of tools designed to distribute digital marketing content over the Internet to target user devices effectively. This content can include, for instance, emails, social media posts, in-app messages, and any other digital marketing content. Goals of content delivery systems include ensuring that the right content reaches the right audience at the right time and in the right format, and through the most appropriate channels.

### SUMMARY

Some aspects of the present technology relate to, among other things, using generative models to generate text of content items and facilitate interactive editing of the content items. In some configurations, different model sets are provided for generating content items of different content types based on fragments or portions of content items for each content type. The model set for a given content type includes a generative model for each fragment of that content type. Additionally, the model set sets forth an execution order for sequentially executing the generative models to generate the text for each fragment.

To initially generate text for a content item of a given content type, user input is received by the content generation system and used to provide an input to a generative model for a root fragment in the execution order of the model set for that content type. After generating the text of the root fragment, the generative model for each subsequent fragment is sequentially executed in the execution order for the model set. In some aspects, the generative model for each subsequent fragment is a custom model that is trained to take as input the text of previous fragment(s) in the execution order. After generating the text of each fragment, the content generation system can provide a content item with that generated text.

In some configurations, after initially generating a content item, the content generation system provides for interacting editing of text of each fragment. The content generation system provides a user interface that presents the text of each fragment and allows the user to select to unfreeze and freeze certain fragments. Based on that user input, the content generation system regenerates text for any unfrozen fragment while maintaining the text for any frozen fragment. When multiple fragments are unfrozen, the text of each unfrozen fragment is sequentially regenerated according to the execution order. If the root fragment is unfrozen, in some aspects, a custom model is used that takes as input any frozen fragments. If a subsequent fragment is unfrozen, in some aspects, the same generative model used to initially generate the subsequent fragment is used to regenerate the text for that subsequent fragment, taking as input the text of any previous fragment in the execution order. If a previous fragment was unfrozen, the regenerated text is used as input. For any unfrozen fragment, in some instances, the user interface can receive user input comprising a piece of text such as initial few words, or a text with some hidden words and the model from the model set regenerates the fragment by completing or otherwise filling the gaps in the user inputted text. The user input can further comprise concepts, topics, or other input to condition the fragment regeneration. After any editing is complete, the content generation system can provide a content item for communication to user devices.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram illustrating an example of content and fragments of the content in accordance with some implementations of the present disclosure;

FIG. 3 is a block diagram illustrating an example showing a directed acyclic graph (DAG) execution order of fragment generative models for content creation in accordance with some implementations of the present disclosure;

FIG. 4 is a diagram illustrating an example user interface for generative model-assisted content generation in accordance with some implementations of the present disclosure;

FIGS. 5A-5C are diagrams illustrating example user interfaces for generative model-assisted interactive content editing in accordance with some implementations of the present disclosure;

FIG. 6 is a flow diagram showing a method for generative model-assisted content generation in accordance with some implementations of the present disclosure;

FIG. 7 is a flow diagram showing a method for generative model-assisted interactive content editing in accordance with some implementations of the present disclosure; and

FIG. 8 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, the term “content item” refers to text-based digital media that is communicated over a network, such as the Internet, to user devices. While text-based, a content item can include other types of modalities in addition to text, such as images and videos. In some aspects, the content item comprises marketing copy (also referred to herein as a marketing message), which includes text that is intended to promote a product or service or to otherwise cause a potential customer to perform some action. A content item can be one of a number of different content types. By way of example only and not limitation, a content item can be an email, a banner advertisement, a social media post, a blog post, or a landing page.

The term “fragment” is used herein to refer to a pre-defined portion of text in a content item. The number and types of fragments for a content item depend on the type of content. By way of example only and not limitation, an email can include the following fragments: a subject line, a preheader, a headline, a body copy, and a call-to-action (CTA). As another example, a banner advertisement can include the following fragments: a heading, a subheading, a body copy, and a CTA.

A “model set” refers to a collection of generative models for generating text of fragments of a content item of a given content type. In accordance with some aspects of the technology described herein, each content type has a defined model set to generate content items. For each content type, the model set includes a generative model specific to each fragment for the content type. For instance, the model set for emails could include a generative model for the subject line, a generative model for the preheader, a generative model for the headline, a generative model for the body copy, and a generative model for the CTA.

As used herein, an “execution order” refers to an order in which generative models in a model set are executed to generated text of fragments of a content item. In accordance with some aspects, generative models in a model set are organized in a directed acyclic graph (DAG) and executed to generate fragments based on the order set forth by the DAG. For example, the execution order for an email could comprise: body copy, headline, CTA, preheader, subject line.

A “root fragment” refers to a fragment of a content item that is generated first in an execution order for a given content type. For instance, a body copy is the root fragment for an email content type having the following execution order: body copy, headline, CTA, preheader, subject line.

A “root generative model” refers to a generative model in a model set used to generate text of a root fragment in the execution order of the model set.

A “subsequent fragment” refers to a fragment of a content item that is generated after a root fragment in an execution order for a given content type. For instance, the headline, CTA, preheader, and subject line are subsequent fragments for an email content type having the following execution order: body copy, headline, CTA, preheader, subject line.

A “subsequent generative model” refers to a generative model in a model set used to generate text of a subsequent fragment in the execution order of the model set.

A “previous fragment” refers to a fragment that occurs before a given subsequent fragment in an execution order for a given content type. For instance, the body copy and headline are previous fragments for the CTA for an email content type having the following execution order: body copy, headline, CTA, preheader, subject line.

As used herein, a “frozen fragment” refers to a fragment that is selected to remain unchanged when editing a content item.

An “unfrozen fragment” refers to a fragment that is selected to be regenerated when editing a content item.

### Overview

Given the vast number of user devices and the incredible amount of content distributed on the Internet, the generation and delivery of content to user devices poses a technical challenge for content delivery systems. For instance, in the current digital marketing era, enterprises face the challenge of creating marketing content items in the form of email ads, display ads, and paid social media ads, in addition to maintaining other forms of online presence, such as blogs and social media accounts, among many others. The need for a plethora of new, unique, and appealing content items that reflect the personality of the enterprise in the form of voice and tone, as well as their overall messaging attributes not limited to writing style, but also its brand definition, presents a significant challenge. Traditionally, many hours of careful human effort are required to create high quality content items that would pass the bar for publishing, as it is tied to the business and revenue for the company, among many other key performance indicators (KPIs).

More recently, enterprises have begun using generative models to assist in the content creation process. For instance, pre-trained large language models (LLMs), such as LLMs from OpenAI, Google, Anthropic, and others, are becoming the modern workhorse of marketing content creation, with marketers and creatives constructing prompts for generating content with specific requirements. The general nature of such LLMs results in the generation of content that often fails to adequately capture the underlying governing data distribution and associated writing styles, linguistic and semantic attributes of past marketing content of a particular brand.

Pretrained LLMs such as GPT-4, Gemini, and Claude offer the capability of text generation. While at a high-level, these LLMs can be used for marketing content generation, their use presents some limitations. The pre-trained models are trained on large scale historic data on the Internet, which enables them to have a generic knowledge of marketing content, but they may not have enough context about specific enterprises. There is also a risk of the generated content being mechanical and generic and not aligning with the brand's personality.

While it is possible to include very specific instructions through in-context examples of past enterprise data in prompts given to LLMs, it typically requires multiple passes through carefully constructed prompts to generate something that satisfactorily aligns with the linguistic dimensions around the brand's voice and tone. Studies have shown that in-context learning can be unstable and very sensitive to the demonstrations included in the prompt. Also, this creates the overhead for creators to pick up the skill of prompt engineering and understand its nuances and limitations. The process is also time consuming due to the multiple back and forth in iterative prompting, which is interventional in nature.

Moreover, the amount of back and forth required between the prompter and the LLM to arrive at acceptable content items often results in the consumption of an unnecessary quantity of computing resources (e.g., I/O costs, network bandwidth usage, throughput, memory consumption, CPU/GPU usage, etc.). For instance, a user may submit an initial prompt, causing the LLM to generate content, which is presented to the user. The user reviews the content from the LLM and issues another prompt to refine the content, causing the LLM to generate new content. The back and forth process of issuing a prompt and generating content by the LLM continues until the user decides the generated content is sufficient or otherwise decides to manually edit the content. Given the unstructured nature of this process, the number of times this back and forth occurs can be extensive.

Each iteration of this conventional process involves consumption of computer resources (e.g., bandwidth, memory, CPU/GPU usage), as well as puts wear and tear on physical computer components. For instance, repetitive prompts adversely affect computer network communications, increasing network bandwidth usage and latency. Additionally, the repetitive inputs from the user and content generation by the LLM increase memory usage, CPU/GPU usage, and storage device I/O (e.g., excess physical read/write head movements on non-volatile disk) because each time a user inputs another prompt, the computing system often has to reach out to the storage device to perform a read or write operation (which is time consuming, error prone, and can eventually wear on components, such as a read/write head) and consume processor and memory resources in executing the LLM to generate the content.

Aspects of the technology described herein improve the functioning of the computer itself in light of these shortcomings in existing technologies by providing a content generation system that provides for improved generative model-assisted content generation and interactive content editing. In accordance with some aspects, a model set is defined for a content item of a given content type, where the model set includes a generative model for each fragment of the content item and an execution order sets forth an order in which each generative model is executed. For instance, an email content type could include the following fragments: a subject line, a preheader, a headline, a body copy, and a call-to-action (CTA). Accordingly, the model set for the email content type includes a generative model for each of these fragments and an execution order for generating each of those fragments. The execution order begins with a root fragment (e.g., body copy) followed by a sequence of the subsequent fragments (e.g., headline, then CTA, then preheader, then subject line).

To initially generate content, the content generation system receives user input that can comprise, for instance: a prompt with instructions regarding the generation of the content item, keywords, topics, an indication of the content type to generate, target product, target recipient, which fragments to generate, number of variants, etc. The model set for the content type of the content item to be generated is accessed, and based on the user input, an input is provided to a generative model for a root fragment in the execution order of the model set to generate text for the root fragment. In some aspects, the generative model for the root fragment is a pre-trained LLM, while in other aspects the generative model is a custom model, for instance, a model that has been fine-tuned on relevant domain knowledge or otherwise fine-tuned to generate the root fragment (e.g., fine-tuned on example root fragments that were manually created). After generating the text of the root fragment, the text of each subsequent fragment in the execution order is sequentially generated using the corresponding generative model for each subsequent fragment. The generative model for each subsequent fragment is a custom model that has been trained to take as input text of any previous fragment in the execution order. For instance, given an execution order for an email in which the CTA is generated after the body copy and the headline, the text generated for the body copy and the text generated for the headline are provided as input to the generative model for the CTA in order to generate the text of the CTA.

In some aspects, after fragments of a content item have been initially generated, a user interface is provided that presents the text of the fragments to facilitate interactive edit. User input is received via the user interface selecting to unfreeze one or more fragments while freezing certain fragments. Based on the user input, the content generation system regenerates text for each unfrozen fragment while maintaining the text of each frozen fragment. When multiple fragments are unfrozen, the unfrozen fragments are regenerated in the execution order. If the root fragment is unfrozen, in some aspects, a different custom generative model (than the model used to initially generate the text of the root fragment) is used to regenerate the root fragment using the text of any frozen fragment as input. If a subsequent fragment is unfrozen, in some aspects, the same generative model used to initially generate the subsequent fragment is used to regenerate the subsequent fragment using any previous fragment in the execution order as input. When there are multiple unfrozen fragments, the input to an unfrozen fragment includes the initial text of any previous frozen fragment in the execution order and the regenerated text of any previous unfrozen fragment in the execution order.

In some aspects, the interactive editing user interface allows for receiving user input for any unfrozen fragment. For instance, the user input can comprise a piece of text such as initial few words, or a text with some hidden words and the model from the model set regenerates the fragment by completing or otherwise filling the gaps in the user inputted text. The user input can further comprise concepts, topics, or other input to condition the fragment regeneration. Once the process is completed, the content item is distributed over a network (e.g., the Internet) to user devices via appropriate communication channels based on the content type of the content item.

Aspects of the technology described herein provide a number of improvements over existing technologies. For instance, the technology described herein employs different generative models for each fragment of a content item. As such, each generative model can be trained to generate text that is specific to each fragment. Additionally, generating the fragments in an execution order ensures that the text of the fragments are consistent with one another. This provides for improved initial content generation compared to the conventional use of a pre-trained generative model to generate a content item in its entirety. In some cases, this approach allows for initial content generation that requires no further editing or only minimal editing, thereby eliminatory or at least reducing the need for extensive back and forth editing of the initial content item. Furthermore, the use of fragment-specific generative models provides for an interactive editing process in which certain fragments can be unfrozen while other fragments are frozen. This reduces the extent of processing as only unfrozen fragments are regenerated as opposed to regenerating the entire content item as in conventional approaches using a pre-trained LLM. Additionally, by focusing on regenerating only certain fragments while freezing other fragments, the content item can be generated with fewer back and forth iterations relative to conventional approaches. Accordingly, aspects of the technology described herein provide for reduced computer resource consumption (e.g., bandwidth, memory, CPU/GPU usage) when compared to conventional LLM-based content generation.

### Example System for Content Generation and Interactive Editing

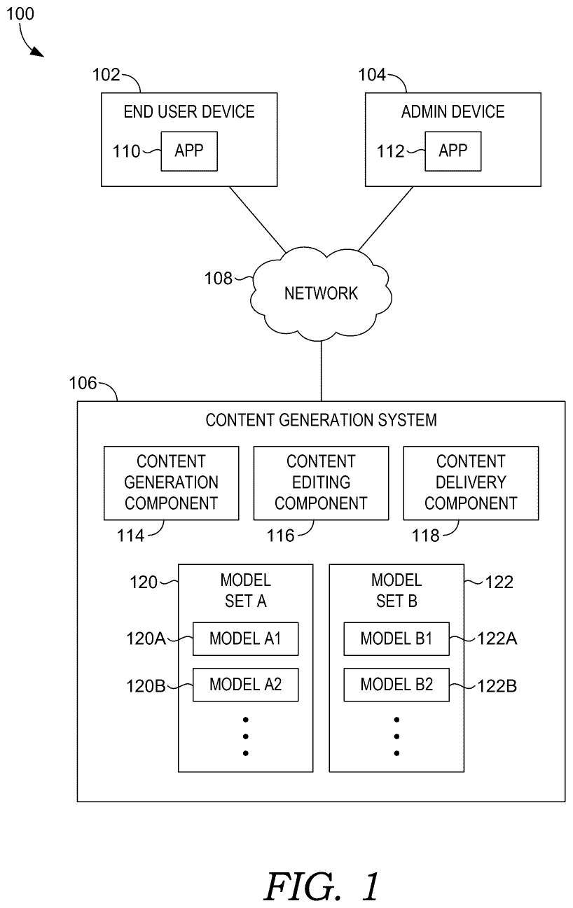

With reference now to the drawings, FIG. 1 is a block diagram illustrating an exemplary system 100 for model-assisted content generation and interactive content editing in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

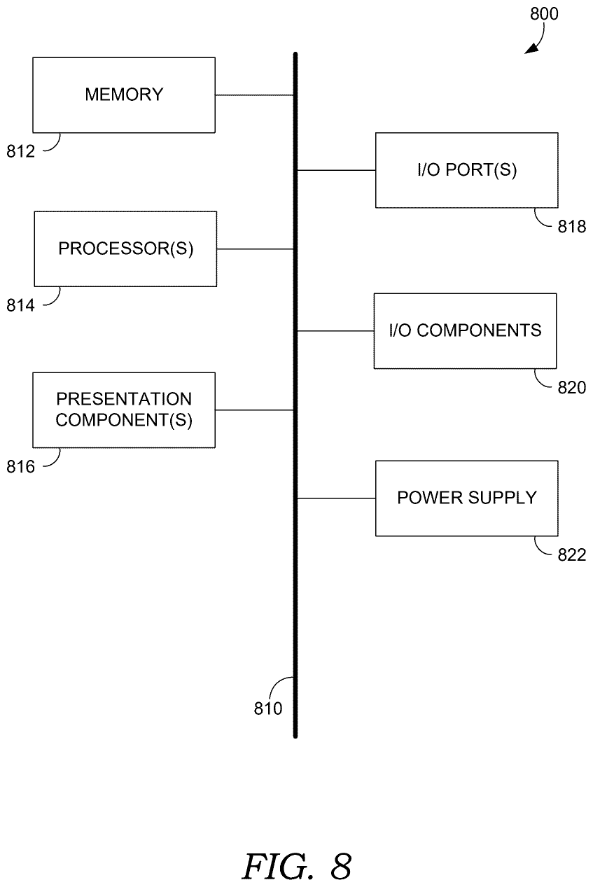

The system 100 is an example of a suitable architecture for implementing certain aspects of the present disclosure. Among other components not shown, the system 100 includes an end user device 102, an admin device 104, and a content generation system 106. Each of the end user device 102, the admin device 104, and the content generation system 106 shown in FIG. 1 can comprise one or more computer devices, such as the computing device 800 of FIG. 8, discussed below. As shown in FIG. 1, the end user device 102, the admin device 104, and the content generation system 106 can communicate via a network 108, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the content generation system 106 could be provided by multiple server devices collectively providing the functionality of the content generation system 106 as described herein. Additionally, other components not shown may also be included within the network environment.

The end user device 102 and the admin device 104 can each be a client device on the client-side of operating environment 100, while the content generation system 106 can be on the server-side of operating environment 100. The content generation system 106 can comprise server-side software designed to work in conjunction with client-side software on the end user device 102 and the admin device 104 so as to implement any combination of the features and functionalities discussed in the present disclosure. For instance, the end user device 102 can include an application 110 and the admin device 104 can have an application 112 for interacting with the content generation system 106. The application 110 and the application 112 can each be, for instance, a web browser or a dedicated application for providing functions, such as those described herein. This division of operating environment 100 is provided to illustrate one example of a suitable environment, and there is no requirement for each implementation that any combination of the end user device 102, the admin device 104, and/or the content generation system 106 remain as separate entities. While the operating environment 100 illustrates a configuration in a networked environment with a separate end user device, admin device, and content generation system, it should be understood that other configurations can be employed in which aspects of the various components are combined. For instance, in some aspects, aspects of the content generation system 106 can be implemented in part or in whole by the end user device 102 and/or the admin device 104.

The end user device 102 and the admin device 104 can each comprise any type of computing device capable of use by a user. For example, in one aspect, the end user device 102 and the admin device 104 may each be the type of computing device 800 described in relation to FIG. 8 herein. By way of example and not limitation, the end user device 102 and the admin device 104 can each be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the end user device 102 and can interact with the content generation system 106 via the end user device 102. As used herein, an end user is an individual who is a recipient of a content item from the content generation system 106. An administrative user can be associated with the admin device 104 and can interact with the content generation system 106 via the admin device 104. As used herein, an administrative user is an individual who interacts with the content generation system 106 to generate a content item for distribution to one or more end users.

The content generation system 106 leverages generative models to generate content items based on input received from administrative users via admin devices, such as the admin device 104. After initial generation of content items, the content generation system 106 also provides for interactive editing of the content items by the administrative users. Once content items are completed, the content generation system 106 facilitates distribution of the content items over the network 108 to end user devices, such as the end user device 102.

As shown in FIG. 1, the content generation system 106 includes a content generation component 114, a content editing component 116, and a content delivery component 118. The modules/components of the content generation system 106 may be in addition to other components that provide further additional functions beyond the features described herein. The content generation system 106 can be implemented using one or more server devices, one or more platforms with corresponding application programming interfaces, cloud infrastructure, and the like. While the content generation system 106 is shown separate from the end user device 102 and the admin device 104 in the configuration of FIG. 1, it should be understood that in other configurations, some or all of the functions of the content generation system 106 can be provided on the end user device 102 and/or the admin device 104. Additionally, in some configurations, one or more of the components of the content generation system 106 shown in FIG. 1 can be provided by the end user device 102, the admin device 104, and/or another location not shown in FIG. 1. The components can be provided by a single entity or multiple entities.

In some aspects, the functions performed by components of the content generation system 106 are associated with one or more applications, services, or routines. In particular, such applications, services, or routines may operate on one or more user devices, servers, may be distributed across one or more user devices and servers, or be implemented in the cloud. Moreover, in some aspects, these components of the content generation system 106 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The content generation component 114 of the content generation system 106 generates initial text for fragments of a content item based on initial user input, for instance, from the admin device 104. The initial user input can comprise, for instance, unstructured text (e.g., a prompt with instructions on how to generate the content item, landing page text, keywords, topics, etc.) and/or structured data (e.g., specifying content type, product, target recipient, which fragments to generate, number of variants to generate, etc.).

The content generation system 106 includes a number of model sets that are used by the content generation component 114 to generate content items, such as the model set 120 and the model set 122. While FIG. 1 provides an example showing two model sets, it should be understood that any number of model sets can be employed. Each model set corresponds to a given content type and includes generative models for the fragments of the given content type. For instance, the model set 120 includes generative model 120A and generative model 120B, and the model set 122 include generative model 122A and generative model 122B. While the model set 120 and the model set 122 in FIG. 1 are each shown with two generative models, each model set can include any number of generative models based on the number of fragments for the corresponding content type. For instance, the model set 120 could correspond to email content type and include a different generative model for each of the following fragments: a subject line, a preheader, a headline, a body copy, and a call-to-action (CTA); while the model set 122 could correspond to banner advertisement content type and include a different generative model for each the following fragments: a heading, a subheading, a body copy, and a CTA.

An execution order is defined for each model set that specifies the order in which the generative models are executed to generate the fragments of content items. In some aspects, the execution order is provided by a directed acyclic graph (DAG). For each model set, the execution order begins with a generative model that generates text for a root fragment, which is followed by generative models that generate text for subsequent fragments in the execution order. In some aspects, the generative model for the root fragment takes input based on the initial user input from the administrative user (e.g., a prompt; input specifying content type, product, target recipient, which fragments to generate, number of variants to generate; text from a landing page; etc.). In contrast to the generative model for the root fragment, the generative model for each subsequent fragment in the execution order takes as input the text generated by generative models of previous fragments in the execution order. This ensures that the text generated for the fragments are consistent with one another.

In operation, given user input to generate a content item of a given content type, the content generation component 114 accesses the model set for the given content type. For instance, if the content type being generated is an email, the content generation component 114 accesses the email model set. The content generation component 114 then executes the generative models of the model set in the execution order for that content type to generate each fragment of the content item. The content generation component 114 initially provides input (based on the user input) to the generative model for the root fragment, causing that generative model to generate text for the root fragment. The content generation component 114 then causes the generative model associated with each subsequent fragment to generate text for the subsequent fragments in the execution order for that content type, where the generative model for each subsequent model takes as input text from previous fragments in the execution order.

For instance, suppose a model set for an email content type includes generative models for the following fragments in their execution order: body copy, headline, CTA, preheader, subject line. In that case, the generative model for the body copy (i.e., the root fragment) is first executed, followed by execution of the generative model for the headline, followed by execution of the generative model for the CTA, followed by execution of the generative model for the preheader, followed by execution of the generative model for the subject line.

Each generative model in a model set, such as the model set 120 or the model set 122, can comprise a language model that includes a set of statistical or probabilistic functions to perform Natural Language Processing (NLP) in order to understand, learn, and/or generate human natural language text. For example, a language model can be a tool that determines the probability of a given sequence of words occurring in a sentence or natural language sequence. Simply put, it can be a model that is trained to predict the next word in a sentence. A language model is called a large language model (LLM) when it is trained on enormous amount of data and/or has a large number of parameters. Some examples of LLMs are GOOGLE's BERT and OpenAI's GPT-3 and GPT-4. These models have capabilities ranging from writing a simple essay to generating complex computer codes—all with limited to no supervision. Accordingly, an LLM can comprise a deep neural network that is very large (e.g., billions to hundreds of billions of parameters) and understands, processes, and produces human natural language by being trained on massive amounts of text. These models can predict future words in a sentence letting them generate sentences similar to how humans talk and write or otherwise in a form dictated, for instance, by a prompt.

In accordance with some aspects, each generative model comprises a neural network. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, the generative model in a model set used by the content generation component 114 to initially generate text for the root fragment is a pre-trained model (e.g., GPT-4, Llama2-7B, etc.) that has not been fine-tuned. In other configurations, the generative model for initially generating text for the root fragment is built and trained from scratch or a pre-trained model that has been fine-tuned. For instance, a generative model for a root fragment of a given content type could be trained/fine-tuned on training data that comprises content items of that given content type (or fragments thereof) and/or other text relevant to the domain (e.g., keywords, topics, etc.).

In some aspects, the generative models in a model set used by the content generation component 114 to generate text for subsequent fragments are customized models. In particular, the generative model for each subsequent fragment is trained to take as input text of previous fragments in the execution order of the model set. The generative models can also be conditioned on training data that comprises content items of that given content type (or fragments thereof) and/or other text relevant to the domain (e.g., keywords, topics, etc.).

By way of example only and not limitation, in some configurations, the custom model for each fragment is trained as a slim, lightweight adapter to be applied to a shared heavy backbone comprising of an open-source LLM (e.g., Llama2-7B), using Low-Rank Adaptation (LoRA) and a supervised fine-tuning approach. For each generative model, (input, output) pairs (i.e., “training pairs”) are created from a relevant content item dataset by chaining of fragments to provide training data to train each generative model. The “input” from a training pair in the training data for a given subsequent fragment is text of previous fragment(s) in the execution order; while the “output” from the training pair is ground truth text for that subsequent fragment. Each generative model could be trained by providing the input from a training pair to the generative model, computing a loss between the text generated by the generative model and the output from the training pair, and updating parameters based on the loss.

LoRA enables fast training of slim adapters by freezing pre-trained weights and learning only the delta in the parameters for each downstream task, by injecting rank decomposable matrices to the selected layers of the underlying model. This thereby reduces the number of trainable parameters by order of magnitude. In turn, this reduces the GPU memory requirement as it eliminates the need to store all optimizer states. Employing this approach minimizes the hardware costs and allows for training multiple custom models quickly, which are all individually small-sized and can be applied to the common LLM backbone on a need basis.

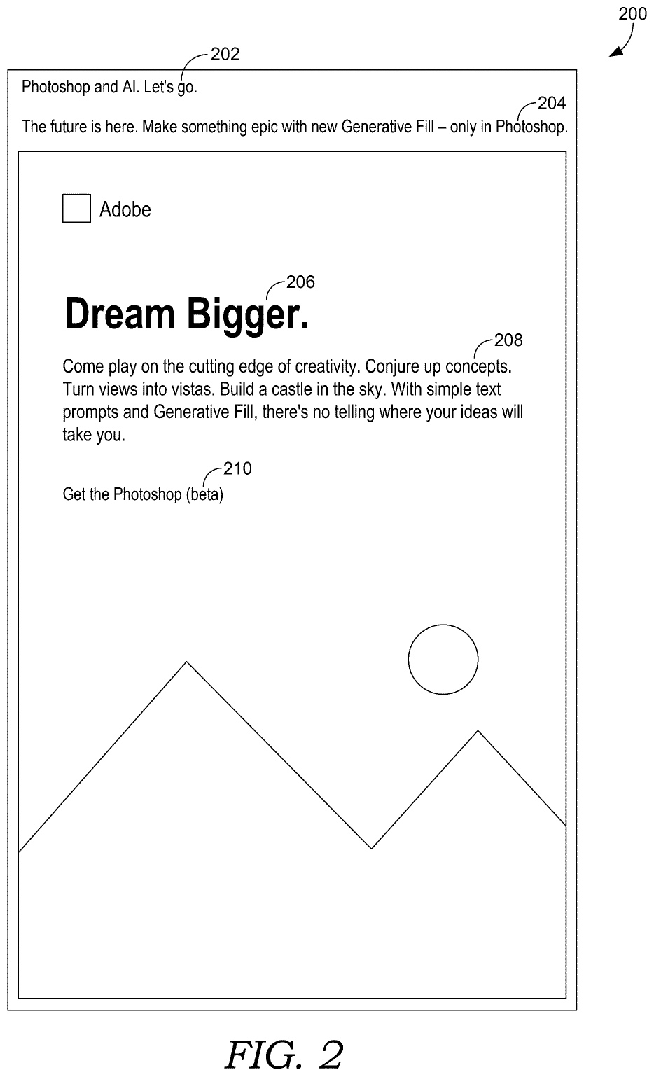

In accordance with some aspects of the technology described herein, the fragments for each content type and the execution order of the generative models for each content type can be based on an entity's guidelines for generating content items of each content type. In particular, entities often have guidelines on what elements are to be included in content items of different content types and the type of information that should be provided, as well as voice and tone of the text. By way of example to illustrate, FIG. 2 shows an example of a content item and its fragments that can be generated in accordance with some aspects of the technology described herein. In particular, FIG. 2 provides an example email 200 that has five fragments: a subject line 202, a preheader 204, a headline 206, a body copy 208 and a CTA 210.

The subject line 202 (“Photoshop and AI. Let's go. ”) is concise and introduces the theme clearly to the reader, while the preheader 204 (“The future is here. Make something epic with Generative Fill—only in Photoshop”) provides more specific details and mentions about the actual feature that is being promoted, in this case—Generative Fill. These are the fragments that the recipient would see before they click open the email 200. On the inside of the email 200, there are several fragments: the headline 206, the body copy 208, and the CTA 210. The headline 206 (“Dream Bigger.”) is meant to grab the attention of the recipient with a punchy statement and guidelines could dictate that it is short and ends with a period. The CTA 210 (“Get the Photoshop (beta)”), on the other hand, is another short piece of text that is straightforward and gives direction for the recipient to the next steps and has no punctuation. The body copy 208 contains the most information for the recipient to take the next step. The guidelines could specify that the body copy 208 uses active, conversational, and intelligent diction to communicate clearly what the product/feature is without getting into the technicalities.

The guidelines for a content type can be used to define the fragments of content items for that content type and the execution order of generative models to generate the fragments. For instance, based on the guidelines for the email 200 of FIG. 2, there is a natural hierarchy and structural flow from one fragment to another. For instance, the body copy 208 is the most text intensive element which directly derives from the campaign objective. Given the body copy 208, the headline 206 could be generated to align with the body copy 208. From these two fragments, the CTA 210 could be generated, followed by the preheader 204 to provide a concise summary of the above, and then the subject line 202 to encompass the theme.

This logical ordering of the fragments of the email 200 in FIG. 2 provides for an execution order of generative models in a model set to generate fragments for emails. This execution order can be in the form of a DAG. In other words, the logical ordering of the fragments in an email allows the email generation problem to be modeled as a structural equation model based on a DAG over these fragments. A generative model is provided for each fragment and the generative models are executed based on the execution order. Given an initial input, the generative model for the root fragment in the execution order generates the root fragment. The generative model for subsequent fragments are customized by training each generative model to accept as input previous fragments in the execution order.

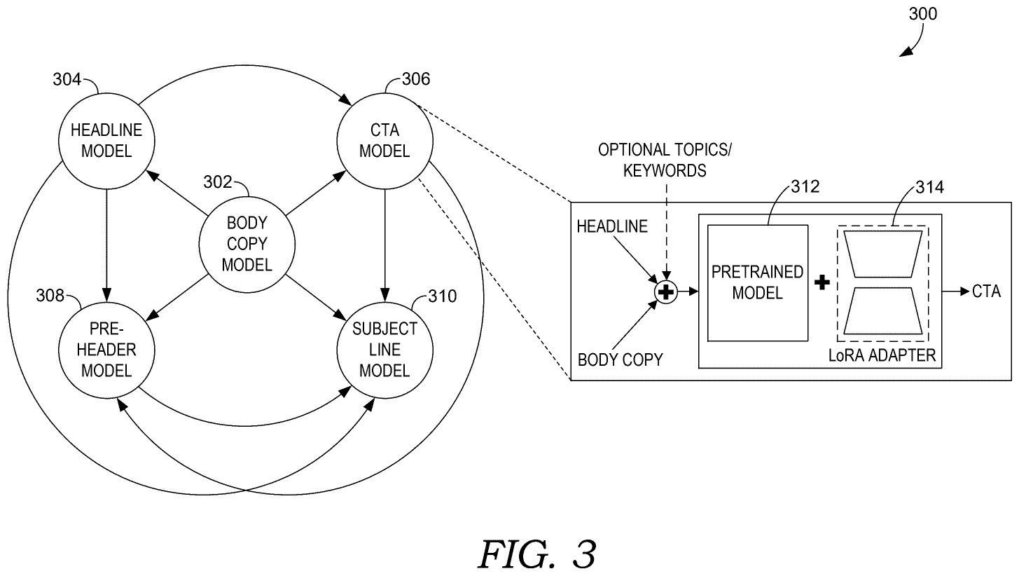

By way of example to illustrate, FIG. 3 shows an execution order for the fragments of the email 200 in FIG. 2. As shown in FIG. 3, the execution order starts with the body copy model 302, which generates a body copy based on initial input. Following the body copy model 302 (i.e., generation of the root fragment), the generative model for each subsequent fragment is customized by training each model to take previous fragments in the execution order as input. In the present example: the headline model 304 takes the body copy as input; the CTA model 306 takes the body copy and the headline as input; the pre-header model 308 takes as input the body copy, the headline, and the CTA; and the subject line model 310 takes as input the body copy, the headline, the CTA, and the pre-header.

FIG. 3 also provides a zoomed in version of the CTA model 306 to illustrate an example of a generative model for a subsequent fragment. As shown in FIG. 3, the CTA model 306 comprises a pretrained model 312 and LoRA adapter 314 that takes as input the text of the body copy (from the body copy model 302) and the text of the headline (from the headline model 304), as well as any optional text (e.g., keywords and/or topics). Other custom models can be extrapolated similarly with the inputs corresponding to the incoming edges of the DAG as well as other optional text such as topics or keywords on the which the generations are conditioned. In particular, as noted above, in some aspects, each of these custom generative models are based on a LLM, and as such, there is flexibility to modify the input to include other textual information on which the fragment generation is conditioned on while training. For example, topics, product information, keywords, and/or other text can be concatenated to the text input. Furthermore, the DAG framework is generic and can be adapted to accommodate any ordering of information flow. Moreover, edges could be added or removed from the DAG to condition the generation of a particular fragment on required combination of the other fragments.

With reference again to FIG. 1, after text has been generated for fragments of a content item by the content generation component 114, the content editing component 116 facilitates interactive editing of the content item. A user interface is provided to the admin device 104 (e.g., via the application 112) that presents the text of the fragments generated by the content generation component 114. The user interface allows an administrative user of the admin device 104 to select to freeze one or more fragments and unfreeze one or more fragments. The text of any frozen fragment is left unchanged, while the text of any unfrozen fragment is regenerated using the corresponding generative model for that fragment. In some aspects, the user interface also allows the administrative user to optionally enter additional text (e.g., text portion, keywords, topics, etc.) to guide the regeneration process. The optional additional text could be universal in that it applies to all fragments and/or could be specific to a particular fragment. In some configurations, the user interface also provides a preview of the content item with the current text for the fragments.

After the administrative user has selected to unfreeze certain fragments, the content editing component 116 uses the generative models for each unfrozen fragment to regenerate the text of that fragment, while the text of any frozen fragment is left unchanged. The unfrozen fragments are regenerated in the execution order of the model set for the content type of the content item.

In some aspects, when a root fragment is unfrozen, a custom generative model is used to generate the text for the root fragment that could be a different generative model than the one used by the content generation component 114 to initially generate the root fragment. In some aspects, the custom generative model for regenerating the root fragment is trained to take as input any frozen fragments. In some configurations, additional text (e.g., topics, keywords, etc.) can also be concatenated with the input as the model is trained, for instance, to condition on these by using an upside-down reinforcement learning approach.

For any subsequent fragment in the execution order that is unfrozen, the content editing component 116 employs the generative model for that fragment to regenerate the text. This could be the same generative model used by the content generation component 114 to initially generate the subsequent fragment. Each subsequent fragment that is unfrozen is regenerated in the execution order for the content type by providing the text of previous fragments in the execution order as input to the generative model for the fragment.

For any unfrozen fragment, the fragment can be regenerated using any additional text provided by the user (e.g., text portion, keywords, topics, etc.) For instance, the additional text can comprise a piece of text such as initial few words, or a text with some hidden words and the model regenerates the fragment by completing or otherwise filling the gaps in the user inputted text. As another example, the additional text can comprise concepts, topics, or other input to condition the fragment regeneration.

The content generation system 106 further includes a content delivery component 118. The content delivery component 118 communicates content items generated by the content generation system 106 over the network 108 to end user devices, such as the end user device 102. Each content item is communicated using appropriate communication channel(s) based on its content type (e.g., email, banner advertisement, social media post, etc.).

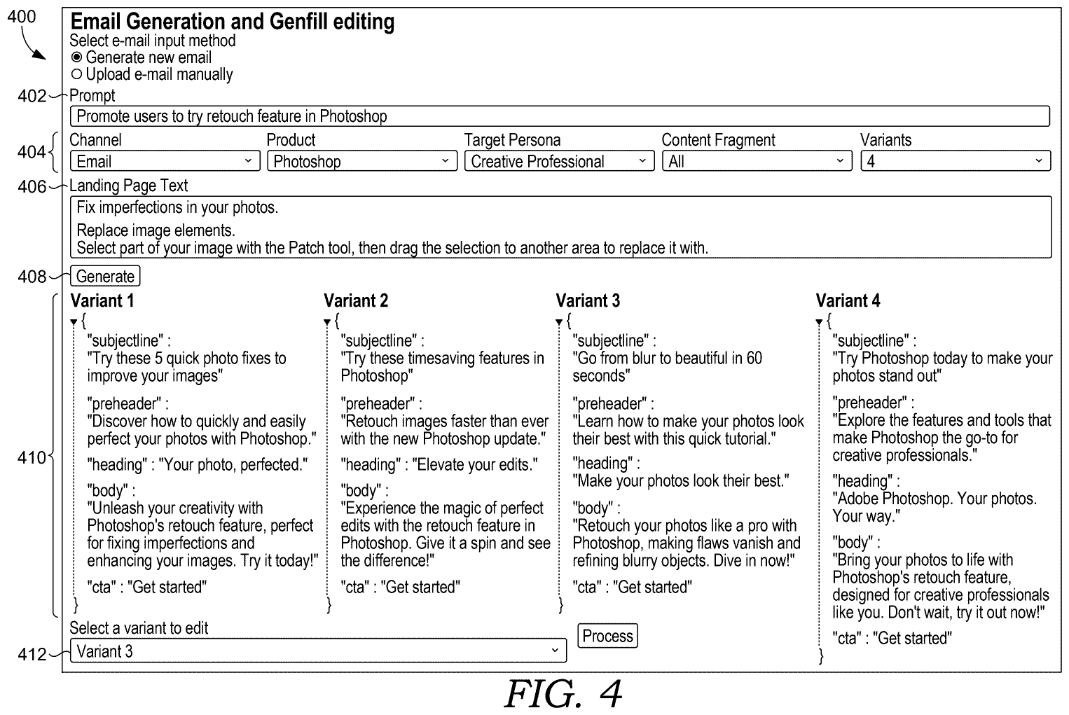

With reference now to FIG. 4, an example is shown of a user interface 400 for initial content generation by the content generation component 114 of FIG. 1. The user interface 400 allows an administrative user to enter input for generating a content item. As shown in FIG. 4, the user interface 400 includes a prompt area 402 in which a user can enter natural language text with instructions on the generation of the content item. The user interface 400 also includes drop down boxes 404 that allow the user to specify certain structured data, including the channel (i.e., content type), product, target recipient, which fragments to generate, and how many variants to generate. The user interface further includes an area 406 for including text from a landing page that is provided when a CTA in the content item is selected by a recipient. The landing page text provides additional information and context for generating fragments for the content item.

After the user enters input, the user can select the generate button 408. Based on the user input, the content generation component 114 of FIG. 1 accesses the model set for the content type identified by the user (i.e., email in this example), and causes the generative models from the model set to generate fragments in the execution order for the model set. For instance, in the example above for FIG. 3, text for a body copy is initially generated, followed by text for a headline, text for a CTA, text for a pre-header, and finally text for a subject line. In the present example, the user has selected to have four variants generated. This causes the model set to provide the input to the generative models of the model set four different time to generate the four variants, which are presented in content area 410 of the user interface 400. Each variant includes fragment labels with the text generated for each fragment. The user can review the variants and select a particular variant for distribution to one or more recipients or for further editing. In the present example, the user has selected variant 3 for editing using drop down box 412.

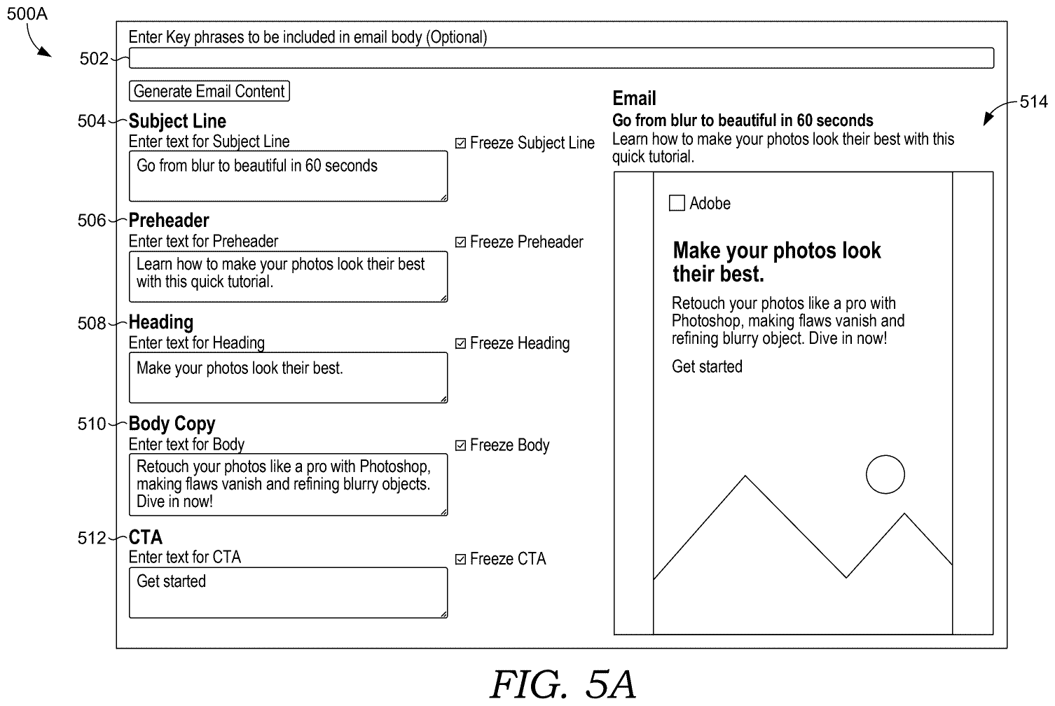

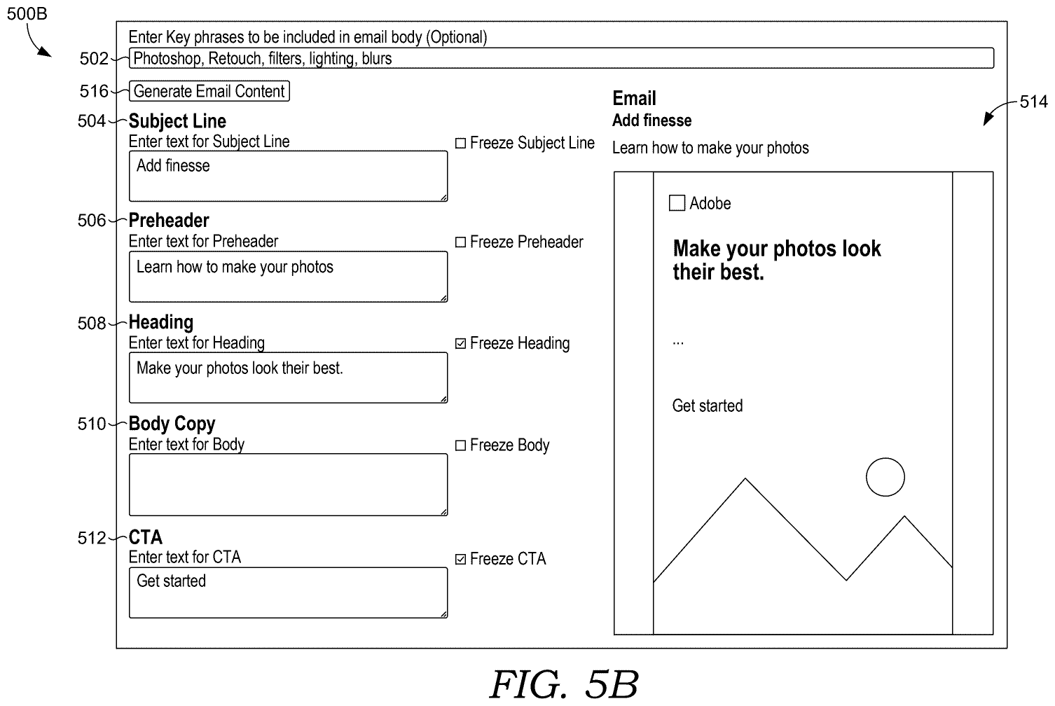

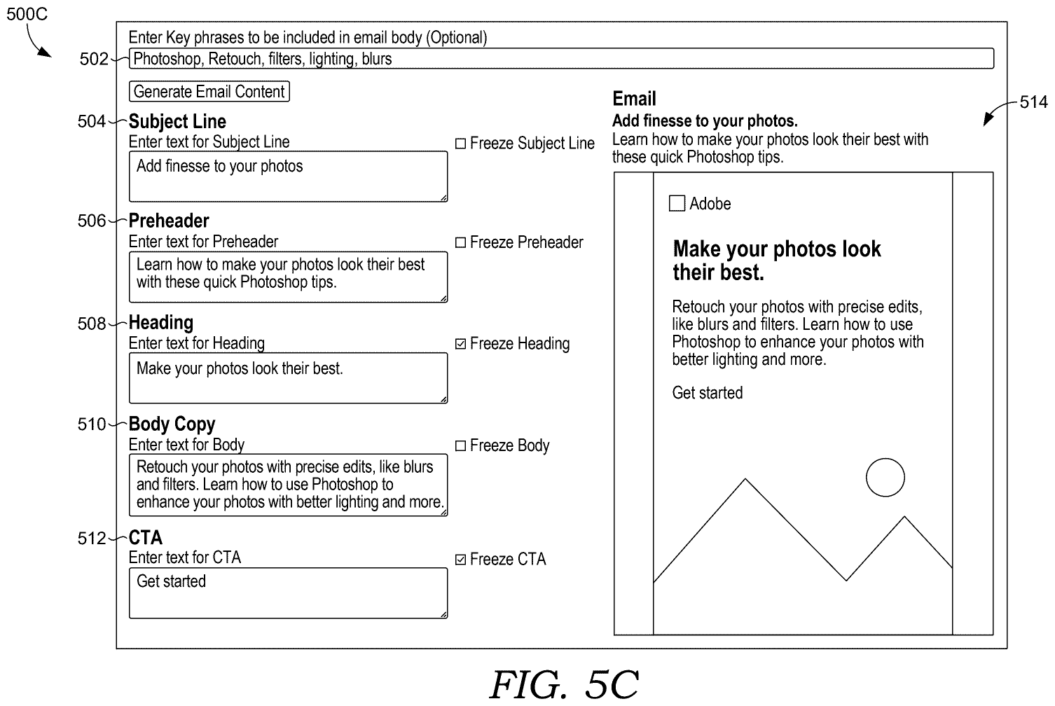

FIGS. 5A-5C provide examples of user interfaces 500A-500C for content editing by the content editing component 116 of FIG. 1. With initial reference to FIG. 5A, a user interface 500A is shown, for instance, in response to the selection of variant 3 in FIG. 4. The user interface 500A includes a subject line fragment editing area 504, a preheader fragment editing area 506, a heading fragment editing area 508, a body copy fragment editing area 510, and a CTA fragment editing area 512. Each fragment editing area is populated with the corresponding text generated by the model set for each fragment. Additionally, a content preview area 514 provides a preview of the content item with the text for each fragment. The user interface 500A further includes a text box 502 for optionally entering additional information (e.g., keywords, topics, etc.) to give the user some control over the editing process.

Each fragment editing area includes a check box for freezing or unfreezing the text for the fragment. This allows the user to review the current text of each fragment and select which fragments to freeze and which fragments to unfreeze. The text of any frozen fragments is maintained, while the text of any unfrozen fragments is regenerated, for instance, by the content editing component 116 of FIG. 1, using the appropriate models from the appropriate model set.

By way of example to illustrate, FIG. 5B shows a user interface 500B in which the user has selected to unfreeze the subject line, the preheader, and the body copy. Additionally, the user has entered text in the subject line fragment editing area 504 and the heading fragment editing area 508 to direct the regeneration of those fragments. Further, the user has entered several keywords in the text box 502 to also direct the regeneration of each of the unfrozen fragments. The user can then select the generate email content button 516 to have the text of the unfrozen fragments regenerated.

FIG. 5C provides a user interface 500C after the user has selected the generate email content button 516 in FIG. 5B to generate email content. The text of the unfrozen fragments is generated in the execution order for the content type (i.e., continuing the example from FIG. 3, the overall execution order is: body copy, headline, CTA, pre-header, and subject line). In the present example, the text of the body copy is initially generated using the text of the frozen fragments (i.e., the heading and the CTA), as well as the keywords entered in the text box 502. The text of the headline and CTA are frozen and therefore not changed. The text of the preheader is generated next using the regenerated body copy, the frozen headline, and the frozen CTA, as well as the text entered in the preheader fragment editing area 506 in FIG. 5B (and in some aspects, the keywords entered in the text box 502). Finally, the text of the subject line is generated using the regenerated body copy, the frozen headline, and the frozen CTA, and the regenerated preheader, as well as the text entered in the subject line fragment editing area 504 in FIG. 5B (and in some aspects, the keywords entered in the text box 502).

FIG. 5C provides the regenerated text for each of the subject line, preheader, and body copy, as well as the frozen text of the heading and CTA. Additionally, the content preview area 514 has been updated to reflect the regenerated text. The user can review the regenerated text and frozen text and determine whether to continue editing (e.g., by freezing and unfreezing certain fragments, and possibly entering different text in the text box 502 and/or one or more of the fragment editing areas). Once finished, the content item (i.e., email) can be distributed to one or more recipients.

### Example Methods for Content Generation and Interactive Editing

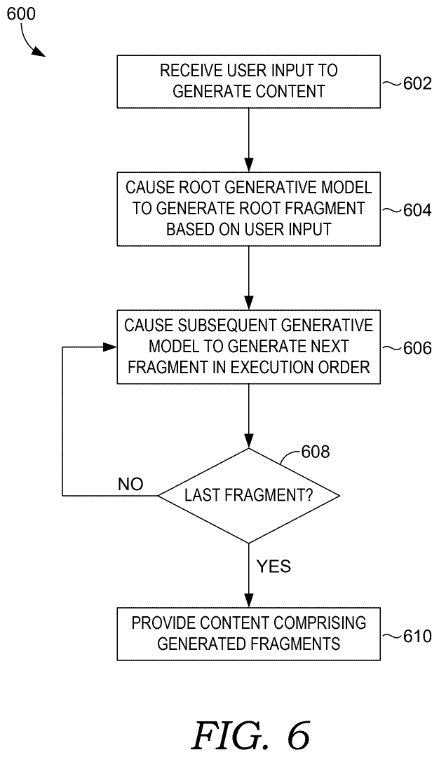

With reference now to FIG. 6, a flow diagram is provided that illustrates a method 600 for generative model-assisted content generation. The method 600 can be performed at least in part, for instance, by the content generation component 114 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, user input is received for generating a content of a particular type and having a number of fragments based on the type of content. For instance, the content could be an email, and the fragments of the email could be a subject line, a preheader, a headline, a body copy, and a CTA. The user input can be in the form of natural language text and/or can include structured data.

Based on the user input, an input is provided to a root generative model for a root fragment in an execution order of the fragments, causing the root generative model to generate text for the root fragment, as shown at block 604. For instance, in the example of an email in which a body copy is the root fragment, the root generative model generates text for the body copy based on the input.

As shown at block 606, an input is provided to a subsequent generative model for a subsequent fragment in the execution order of the fragments, causing the subsequent generative model to generate the subsequent fragment. In accordance with some aspects, the subsequent generative model is a custom model that has been trained to take previous fragment(s) in the execution order as input and to output text for the specific subsequent fragment. For instance, in the example in which the headline of an email is the subsequent fragment after the body copy root fragment, a custom generative model for the headline is given the body copy text as input, causing that custom generative model to output text for the headline.

A determination is made at block 608 regarding whether all fragments have been generated. If not, the process returns to block 606 to generate the next subsequent fragment in the execution order. As noted above, in some aspects, for each iteration at block 606, a custom model specific to each fragment is used, where each custom model has been trained to take text of previous fragment(s) in the execution order as input in order to output text of the specific fragment. The process is repeated until all fragments have been generated. Once it is determined at block 608 that all fragments have been generated, the content comprising the text for all the fragments is provided. For instance, a user interface could be provided that presents the text for each fragment. Once approved, the content item (without or without further editing) can be communicated over a network to a user device (e.g., the end user device 102 of FIG. 1). Alternatively, the content item can be automatically communicated over a network to a user device without review/editing.

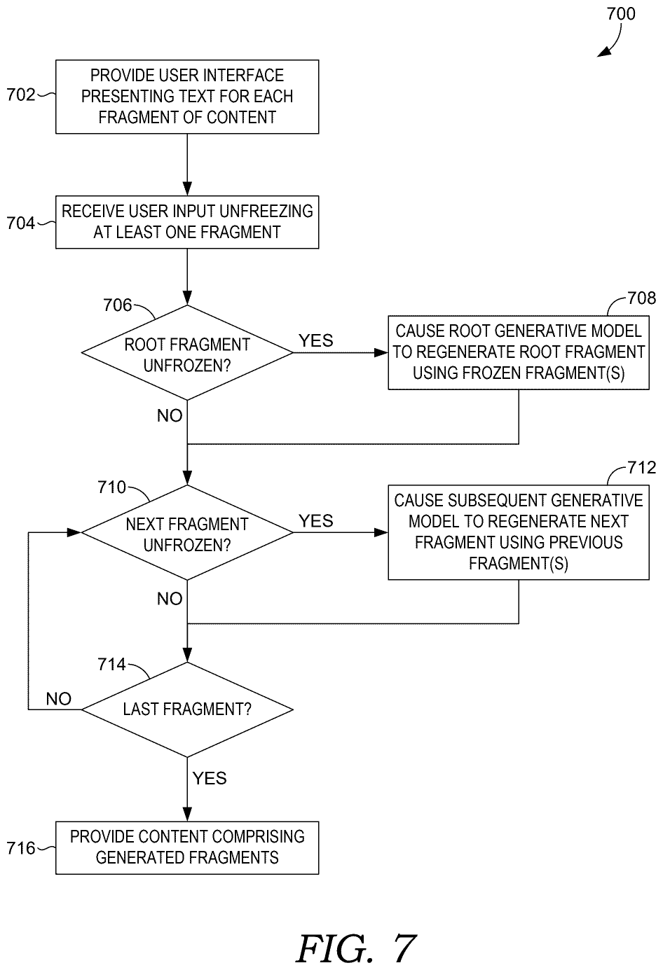

Turning next to FIG. 7, a flow diagram is provided showing a method 700 for generative model-assisted interactive content editing. The method 700 can be performed at least in part, for instance, by the content editing component 116 of FIG. 1. As shown at block 702, a user interface is provided that presents text generated for each fragment of content. For instance, the text could be generated using the method 600 of FIG. 6. By way of example to illustrate, the content could be an email, and the user interface could present text generated for the following fragments of the email: a subject line, a preheader, a headline, a body copy, and a CTA.

User input is received unfreezing one or more fragments while freezing one or more other fragments, as shown at block 704. A determination is made at block 706 regarding whether the root fragment is unfrozen. If the root fragment is unfrozen, a generative model for the root fragment is caused to regenerate the root fragment using any frozen fragments as input, as shown at block 708. In some instances, additional user input (e.g., text portion, keywords, topics, etc.) is also received and used by the generative model to regenerate the root fragment. For instance, the additional user input can comprise a piece of text such as initial few words, or a text with some hidden words and the model regenerates the root fragment by completing or otherwise filling the gaps in the user inputted text. In some instances, the user input can further comprise concepts, topics, or other input to condition the root fragment regeneration.

After determining the root fragment is frozen or regenerating the root fragment when it is unfrozen, a determination is made at block 710 regarding whether the next fragment in the execution order of the fragments is unfrozen. If the next fragment is unfrozen, a generative model for the next fragment is caused to regenerate text for that fragment using previous fragment(s) in the execution order as input, as shown at block 712. In some instances, additional user input (e.g., text portion, keywords, topics, etc.) is also used by the generative model to regenerate the subsequent fragment. For instance, the additional user input can comprise a piece of text such as initial few words, or a text with some hidden words and the model regenerates the subseqent fragment by completing or otherwise filling the gaps in the user inputted text. In some instances, the user input can further comprise concepts, topics, or other input to condition the subsequent fragment regeneration.

After determining the next fragment is frozen or regenerating the next fragment when it is unfrozen, a determination is made at block 714 regarding whether the last fragment in the execution order has been processed. If not, the process returns to block 710 to determine if the next fragment is unfrozen, and the next fragment is regenerated at block 712 when unfrozen. Alternatively, once all fragments have been processed, the content comprising the text for all the fragments is provided, as shown at block 716. For instance, the user interface could be updated to present the text of the frozen fragment(s) and the regenerated text for the unfrozen fragment(s). Once approved, the content item can be communicated over a network to a user device (e.g., the end user device 102 of FIG. 1).

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving user input for generating a content item of a content type having a plurality of fragments;
identifying a model set for the content type, the model set comprising a plurality of generative models for the plurality of fragments and an execution order specifying an order for generating the plurality of fragments;
causing a root generative model from the model set to generate text for a root fragment in the execution order based on the user input;
sequentially causing each subsequent generative model in the model set to generate text for each subsequent fragment from the plurality of fragments in the execution order for the model set, wherein input for each subsequent generative model includes text of one or more previous fragments in the execution order; and
generating the content item by combining the text of each of the plurality of fragments.

2. The one or more computer storage media of claim 1, wherein the execution order comprises a directed acyclic graph.

3. The one or more computer storage media of claim 1, wherein the user input specifies the content type for the content item.

4. The one or more computer storage media of claim 1, wherein the input to each subsequent generative model includes additional text provided in the user input.

5. The one or more computer storage media of claim 1, wherein the operations further comprise:
providing a user interface presenting the text of each of the plurality of fragments.
receiving a second user input to unfreeze a selected fragment from the plurality of fragments;
causing a generative model for the selected fragment to regenerate text for the selected fragment; and
updating the user interface to present the regenerated text for the selected fragment.

6. The one or more computer storage media of claim 5, wherein the operations further comprise:
receiving inputted text for the selected fragment, the inputted text comprising one or more selected from the following: a text portion, a keyword, and a topic; and
wherein the generative fragment regenerates text for the selected fragment using the inputted text.

7. The one or more computer storage media of claim 5, wherein the selected fragment comprises the root fragment, and wherein the regenerated text for the root fragment is generated by a second root generative model using the text of one or more subsequent fragments that have been frozen.

8. The one or more computer storage media of claim 5, wherein the selected fragment comprises a selected subsequent fragment, and wherein the regenerated text for the selected subsequent fragment is generated by the subsequent generative model for the selected subsequent fragment using the text one or more previous fragments in the execution order.

9. A computer-implemented method comprising:
generating, by a content generation component, text of each of a plurality of fragments of a content item;
providing, by a content editing component, a user interface presenting the text of each fragment;
receiving, by the content editing component, user input selecting to unfreeze one or more selected fragments from the plurality of fragments while freezing one or more other fragments from the plurality of fragments;
causing a generative model for each selected fragment to regenerate text of each selected fragment in an execution order for the content item while maintaining the text of each of the one or more other fragments; and
providing, by a content delivery content, the content item to a user device, the content item comprising the regenerated text of each selected fragment and the text of each of the one or more other fragments.

10. The computer-implemented method of claim 9, wherein generating the text of each of a plurality of fragments of the content item by the content generation component comprises:
receiving user input for generating the content item, wherein the user input specifies a content type for the content item;
identifying a model set for the content type, the model set comprising a plurality of generative models for the plurality of fragments and an execution order specifying an order for generating the plurality of fragments;
causing a root generative model from the model set to generate text for a root fragment in the execution order based on the user input;
sequentially causing each subsequent generative model in the model set to generate text for each subsequent fragment from the plurality of fragments in the execution order for the model set, wherein input for each subsequent generative model includes text of one or more previous fragments in the execution order; and
generating the content item by combining the text of each of the plurality of fragments.

11. The computer-implemented method of claim 10, wherein the input to each subsequent generative model includes additional text provided in the user input.

12. The computer-implemented method of claim 9, wherein the operations further comprise:
updating the user interface to present the regenerated text for each selected fragment.

13. The computer-implemented method of claim 9, wherein the one or more selected fragments comprise a root fragment in the execution order, and wherein the regenerated text for the root fragment is generated by a root generative model using the text of the one or more other fragments.

14. The computer-implemented method of claim 9, wherein the one or more selected fragment comprises a selected subsequent fragment in the execution order, and wherein the regenerated text for the selected subsequent fragment is generated by a subsequent generative model for the selected subsequent fragment using the text of one or more previous fragments for the selected subsequent fragment in the execution order.

15. The computer-implemented method of claim 14, wherein the one or more selected fragment comprises a second selected subsequent fragment that is after the selected subsequent fragment in the execution order, and wherein the regenerated text for the second selected subsequent fragment is generated by a second subsequent generative model for the second selected subsequent fragment using the text of one or more previous fragments for the second selected subsequent fragment in the execution order including the regenerated text for the selected subsequent fragment.

16. The computer-implemented method of claim 14, wherein the method further comprises receiving a second user input via the user interface presenting the text of each fragment provided by the content editing component, the second user input comprising text for regenerating the selected subsequent fragment; and wherein the regenerated text for the selected subsequent fragment is generated by the subsequent generative model for the selected subsequent fragment using the text provided in the second user input.

17. A computer system comprising:
one or more processors; and
one or more computer storage media storing computer-useable instructions that, when used by the one or more processors, causes the computer system to perform operations comprising:
receiving, by a content generation component, user input for generating a content item of a content type having a plurality of fragments;
accessing, by the content generation component, a model set for the content type, the model set comprising a plurality of generative models for the plurality of fragments and an execution order specifying an order for generating the plurality of fragments;
causing a first generative model from the model set to generate text for a root fragment in the execution order based on the user input;
causing a second generative model to generate text for a second fragment in the execution order using the text for the root fragment as input;
causing a third generative model to generate text for a third fragment in the execution order using the text for the root fragment and the text of the second fragment as input; and
generating, by a content delivery component, the content item by combining the text of the root fragment, the text of the second fragment, and the text of the third fragment.

18. The computer system of claim 17, wherein the operations further comprise:
providing a user interface that presents the text of the root fragment, the text of the second fragment, and the text of the third fragment;
receiving a second user input via the user interface to unfreeze the root fragment while freezing the second fragment and the third fragment; and
causing a fourth generative model to regenerate text of the root fragment using the text of the second fragment and the text of the third fragment.

19. The computer system of claim 17, wherein the operations further comprise:
providing a user interface that presents the text of the root fragment, the text of the second fragment, and the text of the third fragment;
receiving a second user input via the user interface to unfreeze the third fragment while freezing the root fragment and the second fragment; and
causing the third generative model to regenerate text of the third fragment using the text of the root fragment and the text of the second fragment.

20. The computer system of claim 17, wherein the operations further comprise:
providing a user interface that presents the text of the root fragment, the text of the second fragment, and the text of the third fragment;
receiving a second user input via the user interface to unfreeze the second fragment and the third fragment while freezing the root fragment;
causing the second generative model to regenerate text of the second fragment using the text of the root fragment; and
causing the third generative model to regenerate text of the third fragment using the text of the root fragment and the regenerated text of the second fragment.
